(19) United States
(12) Patent Application Publication
(10) Pub. No.: US 2025/0253356 A1
(43) Pub. Date: Aug. 7, 2025

(54) SINGLE CELL FOR FUEL CELL

(71) Applicant: TOYOTA BOSHOKU KABUSHIKI KAISHA, Aichi-ken (JP)

(72) Inventor: Haruyuki AONO, Aichi-ken (JP)

(73) Assignee: TOYOTA BOSHOKU KABUSHIKI KAISHA, Aichi-ken (JP)

(21) Appl. No.: 19/035,310

(22) Filed: Jan. 23, 2025

(30) Foreign Application Priority Data
Feb. 6, 2024 (JP) 2024-016284
Feb. 21, 2024 (JP) 2024-024503

(51) Int. Cl. H01M 8/026; H01M 8/0267; H01M 8/1004

(52) U.S. Cl. CPC H01M 8/026; H01M 8/0267; H01M 8/1004

(57) ABSTRACT

A single cell for a fuel cell includes a power generating unit and two separators that sandwich the power generating unit. Each separator includes an opposing surface opposed to the power generating unit. The opposing surface has a gas passage and ribs. The gas passage includes a mesh portion, an inflow portion configured such that reactant gas flows through the inflow portion into the mesh portion, and an outflow portion configured such that the reactant gas flows through the outflow portion from the mesh portion. The ribs forming a lattice pattern include ribs arranged in one direction. A length of each of the ribs arranged in the one direction increases or decreases from the inflow portion toward the outflow portion in a stepwise manner for at least one of the ribs.

### CROSS-REFERENCE TO RELATED APPLICATIONS

This application is based upon and claims the benefit of priority from Japanese Patent Application No. 2024-016284, filed on Feb. 6, 2024, and Japanese Patent Application No. 2024-024503, filed on Feb. 21, 2024, the entire contents of each of which are incorporated herein by reference.

### BACKGROUND

### 1. Field

The present disclosure relates to a single cell for a fuel cell.

### 2. Description of Related Art

Japanese Laid-Open Patent Publication No. 2022-182065 discloses an example of a single cell for a fuel cell. Such single cells are structured such that a power generating unit supported by a frame member is sandwiched between two separators. Each separator includes a groove passage that supplies reactant gas to the power generating unit. The groove passage of the separator extends in a wavy manner. The groove passage also includes branch passages and a merging section where the branch passages merge from the upstream side toward the downstream side.

In the above-mentioned single cell for a fuel cell, for the groove passage of each separator structured as described above, there is still room for improvement in efficiently supplying reactant gas to the power generating unit.

Further, in the above-mentioned single cell for a fuel cell, for the groove passage of each separator structured as described above, there is still room for improvement in uniformly supplying reactant gas to the entire power generating unit.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A single cell for a fuel cell according to a first aspect of the present disclosure includes a power generating unit that includes a membrane electrode assembly and two separators that sandwich the power generating unit. Each of the separators includes an opposing surface opposed to the power generating unit. The opposing surface has a gas passage configured such that reactant gas flows through the gas passage and ribs adjacent to the gas passage. The gas passage includes a mesh portion formed in a lattice pattern on a region of the opposing surface corresponding to the power generating unit, an inflow portion connected to one end of the mesh portion in one direction and configured such that the reactant gas flows through the inflow portion into the mesh portion, and an outflow portion connected to the other end of the mesh portion opposite to the one end in the one direction and configured such that the reactant gas flows through the outflow portion from the mesh portion. The lattice pattern of the mesh portion is formed by the ribs. The ribs forming the lattice pattern include ribs arranged in the one direction. A length of each of the ribs arranged in the one direction increases or decreases from the inflow portion toward the outflow portion in a stepwise manner for at least one of the ribs.

A single cell for a fuel cell according to a second aspect of the present disclosure includes a power generating unit that includes a membrane electrode assembly and two separators that sandwich the power generating unit. Each of the separators includes an opposing surface opposed to the power generating unit. The opposing surface has a gas passage configured such that reactant gas flows through the gas passage. The gas passage includes a mesh portion formed in a lattice pattern on a region of the opposing surface corresponding to the power generating unit, an inflow portion provided at a first end of the mesh portion in one direction and configured such that the reactant gas flows through the inflow portion into the mesh portion, an outflow portion provided at a second end of the mesh portion opposite to the first end in the one direction and configured such that the reactant gas flows through the outflow portion from the mesh portion, and a restrictive passage that is a part of the mesh portion and is configured to have a greater pressure loss when the reactant gas flows compared to other parts of the mesh portion. The restrictive passage is arranged in the mesh portion to connect the inflow portion to the outflow portion by a shortest distance.

A single cell for a fuel cell according to a third aspect of the present disclosure includes a power generating unit that includes a membrane electrode assembly and two separators that sandwich the power generating unit. Each of the separators includes an opposing surface opposed to the power generating unit, the opposing surface having a gas passage configured such that reactant gas flows through the gas passage. The gas passage includes a mesh portion formed in a lattice pattern on a region of the opposing surface corresponding to the power generating unit, an inflow portion provided at a first end of the mesh portion in one direction and configured such that the reactant gas flows through the inflow portion into the mesh portion, an outflow portion provided at a second end of the mesh portion opposite to the first end in the one direction and configured such that the reactant gas flows through the outflow portion from the mesh portion, and a restrictive passage that is a part of the mesh portion and is configured to have a greater pressure loss when the reactant gas flows compared to other parts of the mesh portion. The restrictive passage is arranged in the mesh portion to separate the inflow portion from the outflow portion.

Other features and aspects will be apparent from the following detailed description, the drawings, and the claims.

### BRIEF DESCRIPTION OF THE DRAWINGS

FIG. 1 is a cross-sectional view showing a fuel cell stack that includes a single cell for a fuel cell according to a first embodiment.

FIG. 2 is an exploded perspective view of the single cell shown in FIG. 1.

FIG. 3 is a plan view of the gas passage of the separator shown in FIG. 1.

FIG. 4 is a plan view illustrating the positional relationship between the gas passages of the two separators in the single cell shown in FIG. 1.

FIG. 5 is a plan view illustrating the gas passage of the separator in a modification.

FIG. 6 is a plan view illustrating the gas passage of the separator in a modification.

FIG. 7 is a plan view illustrating the gas passage of the separator in a modification.

FIG. 8 is a plan view illustrating the gas passage of the separator in a modification.

FIG. 9 is a plan view illustrating the gas passage of the separator in a modification.

FIG. 10 is a cross-sectional view showing a fuel cell stack that includes a single cell for a fuel cell according to a second embodiment.

FIG. 11 is an exploded perspective view of the single cell shown in FIG. 10.

FIG. 12 is a plan view of the gas passage of the separator shown in FIG. 10.

FIG. 13 is a plan view illustrating the angle of the rib of the separator shown in FIG. 10.

FIG. 14 is a plan view illustrating the positional relationship between the gas passages of the two separators in the single cell shown in FIG. 10.

FIG. 15 is a plan view illustrating the gas passage of the separator in a modification.

FIG. 16 is a plan view illustrating the gas passage of the separator in a modification.

FIG. 17 is a plan view illustrating the gas passage of the separator in a modification.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

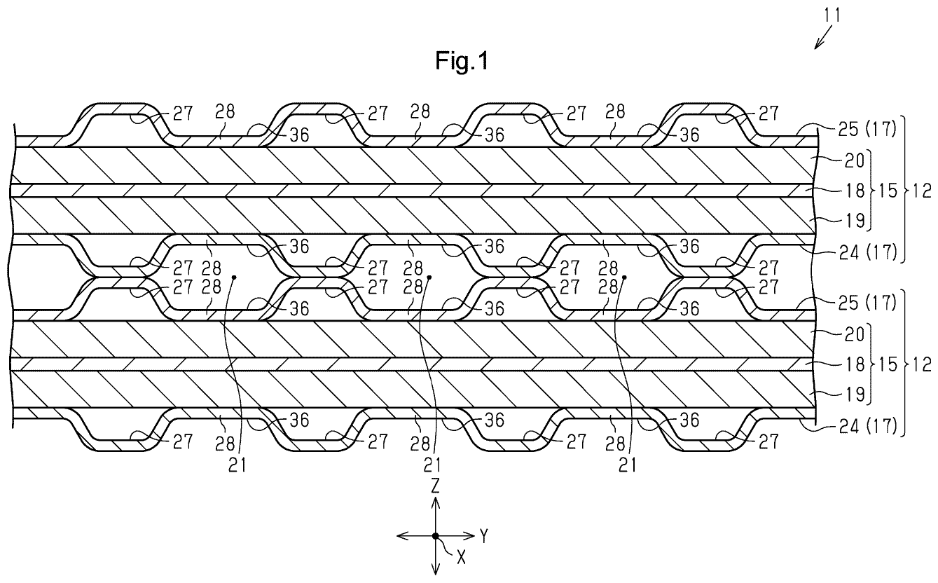

A single cell 12 for a fuel cell according to a first embodiment will now be described with reference to FIGS. 1 to 4.

### Fuel Cell Stack 11

As shown in FIG. 1, a fuel cell stack 11 includes plate-shaped single cells 12 stacked on one another.

### Single Cell 12

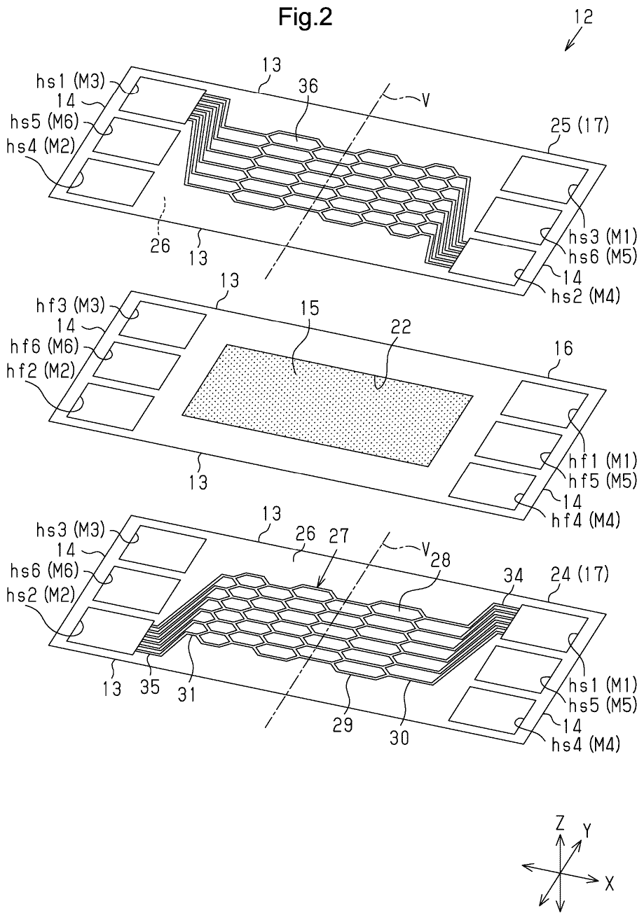

As shown in FIG. 2, the single cell 12 has the shape of, for example, a rectangular plate. That is, the single cell 12 includes two long sides 13, which extend parallel to each other, and two short sides 14, which are orthogonal to the long sides 13 and extend parallel to each other.

Hereinafter, a stacking direction Z that coincides with the thickness direction of the single cell 12 will simply be referred to as the stacking direction Z. The direction in which the long sides 13 extend will be referred to as the X-axis direction, and the direction in which the short sides 14 extend will be referred to as the Y-axis direction. The stacking direction Z, the X-axis direction, and the Y-axis direction are orthogonal to one another.

The single cell 12 includes a fuel gas supply manifold M1, which supplies fuel gas to the single cell 12, a fuel gas discharge manifold M2, which discharges fuel gas to the outside of the single cell 12. Further, the single cell 12 includes an oxidant gas supply manifold M3, which supplies oxidant gas to the single cell 12, and an oxidant gas discharge manifold M4, which discharges oxidant gas to the outside of the single cell 12.

As shown in FIGS. 1 and 2, each single cell 12 includes two cooling medium supply manifolds M5, which supply cooling medium to the fuel cell stack 11, and two cooling medium discharge manifolds M6, which discharge cooling medium to the outside of the fuel cell stack 11. The manifolds M1 to M6, for example, have a rectangular shape.

As shown in FIG. 2, the fuel gas supply manifold M1, the cooling medium supply manifold M5, and the oxidant gas discharge manifold M4 are located at the end of the single cell 12 on one side in the X-axis direction. The fuel gas supply manifold M1, the cooling medium supply manifold M5, and the oxidant gas discharge manifold M4 are arranged in this order from one side to the other in the Y-axis direction. The fuel gas discharge manifold M2, the refrigerant discharge manifold M6, and the oxidant gas supply manifold M3 are located at the end of the single cell 12 on the other side in the X-axis direction, which is opposite to the one side in the X-axis direction. The fuel gas discharge manifold M2, the refrigerant discharge manifold M6, and the oxidant gas supply manifold M3 are arranged in this order from the other side to the one side in the Y-axis direction. Fuel gas is, for example, hydrogen. Oxidant gas is, for example, air. Cooling medium is, for example, water.

The single cell 12 includes a power generating unit 15, a frame 16, and two separators 17. The power generating unit 15 has the shape of a sheet. The frame 16 surrounds the outer edge of the power generating unit 15. The two separators 17 sandwich the power generating unit 15 and the frame 16 from the opposite sides in the stacking direction Z. The power generating unit 15 and the separator 17 have, for example, a rectangular shape in plan view. The frame 16 has the shape of, for example, a rectangular frame in plan view.

### Power Generating Unit 15

As shown in FIG. 1, each power generating unit 15 includes a membrane electrode assembly 18, an anode-side gas diffusion layer 19, and a cathode-side gas diffusion layer 20. The anode-side gas diffusion layer 19 and the cathode-side gas diffusion layer 20 sandwich the membrane electrode assembly 18. Although not illustrated, the membrane electrode assembly 18 includes an electrolyte membrane, an anode electrode catalyst layer, and a cathode electrode catalyst layer. The anode electrode catalyst layer and the cathode electrode catalyst layer sandwich the electrolyte membrane. The anode-side gas diffusion layer 19 is stacked on the anode electrode catalyst layer. The cathode-side gas diffusion layer 20 is stacked on the cathode electrode catalyst layer.

Referring to FIGS. 1 and 2, fuel gas is supplied to the anode-side surface of the power generating unit 15 through the fuel gas supply manifold M1. Oxidant gas is supplied to the cathode-side surface of the power generating unit 15 through the oxidant gas supply manifold M3. As a result, the power generating unit 15 generates power from the electrochemical reaction between the fuel gas and the oxidant gas.

In the fuel cell stack 11, each single cell 12 generates heat during the power generation of the power generating unit 15. Thus, the fuel cell stack 11 has cooling passages 21, which will be described later. Cooling medium is supplied to the cooling passages 21 through the cooling medium supply manifolds M5.

### Frame 16

Referring to FIG. 2, the frame 16 is made of an insulating plastic. The frame 16 includes a middle portion having an accommodating hole 22 that accommodates the power generating unit 15. The frame 16 includes through-holes hf1 to hf6, which respectively define manifolds M1 to M6, on the outer side of the accommodating hole 22.

### Separators 17

Referring to FIGS. 1 and 2, each separator 17 is formed by pressing a metal (e.g., stainless steel or titanium alloy) plate. One of the two separators 17 is disposed on the anode-side surface of the power generating unit 15, and the other is disposed on the cathode-side surface of the power generating unit 15.

Hereinafter, the separator 17 located on the anode-side surface of the power generating unit 15 may be referred to as the anode separator 24, and the separator 17 located on the cathode-side surface of the power generating unit 15 may be referred to as the cathode separator 25.

The anode separator 24 and the cathode separator 25 have an identical structure. The anode separator 24 and the cathode separator 25 are arranged in orientations that are inverted relative to each other about a hypothetical axis V, with respect to the power generating unit 15. The hypothetical axis V passes through the center of the separator 17 in the X-axis direction and extends in the Y-axis direction.

The separator 17 has through-holes hs1 to hs6, which respectively define the manifolds M1 to M6. As described above, the anode separator 24 and the cathode separator 25 are arranged in orientations that are inverted with respect to the power generating unit 15. Thus, the through-hole hs1 of the anode separator 24 is continuous with the through-hole hs3 of the cathode separator 25, and the through-hole hs2 of the anode separator 24 is continuous with the through-hole hs4 of the cathode separator 25.

The through-hole hs3 of the anode separator 24 is continuous with the through-hole hs1 of the cathode separator 25, and the through-hole hs4 of the anode separator 24 is continuous with the through-hole hs2 of the cathode separator 25. The through-hole hs5 of the anode separator 24 is continuous with the through-hole hs6 of the cathode separator 25, and the through-hole hs6 of the anode separator 24 is continuous with the through-hole hs5 of the cathode separator 25.

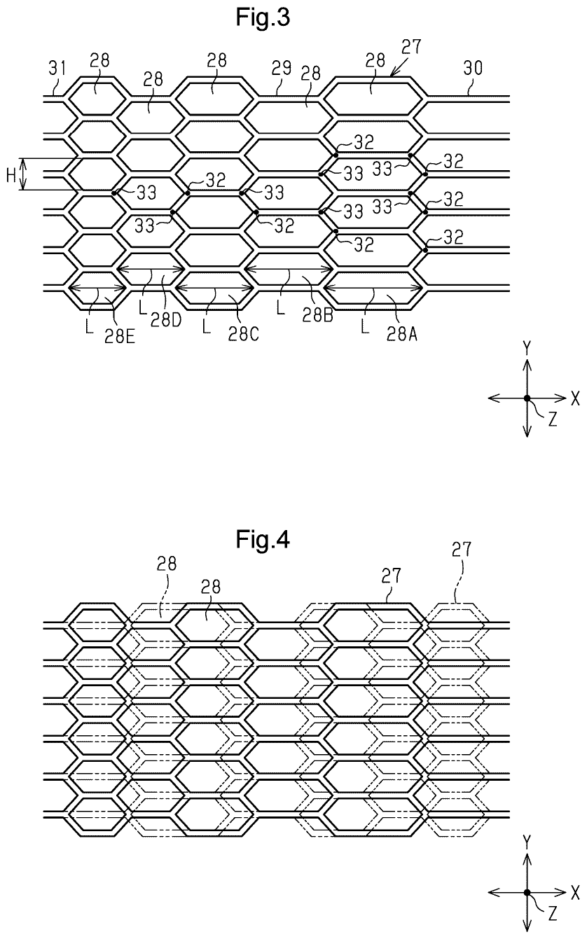

As shown in FIGS. 2 and 3, each separator 17 includes an opposing surface 26 opposed to the power generating unit 15. The opposing surface 26 has a groove-shaped gas passage 27 through which reactant gas flows, and ribs 28 adjacent to the gas passage 27. The gas passage 27 includes a mesh portion 29 formed in a lattice pattern, an inflow portion 30 through which reactant gas is drawn into the mesh portion 29, and an outflow portion 31 through which the reactant gas is discharged from the mesh portion 29.

The mesh portion 29 of the gas passage 27 is arranged in a region of the opposing surface 26 that is substantially rectangular in plan view, corresponding to the power generating unit 15. The lattice pattern of the mesh portion 29 is formed by multiple ribs 28. Thus, in the mesh portion 29, the gas passage 27 extends so as to surround the ribs 28. That is, in the mesh portion 29, the gas passage 27 extends along the contour of the ribs 28. The ribs 28 each have a hexagonal shape in plan view in the present embodiment. The mesh portion 29 of the gas passage 27 includes multiple branching sections 32 where a single passage divides into two passages, and multiple merging sections 33 where two passages merge into one.

The ribs 28, which define the lattice pattern of the mesh portion 29, are arranged side by side in both the X-axis direction and the Y-axis direction. The X-axis direction is an example of one direction. The Y-axis direction is an example of a direction that is orthogonal to the one direction. The length L of each of the ribs 28 in the X-axis direction, which define the lattice pattern of the mesh portion 29 and are arranged in the X-axis direction, decreases from the inflow portion 30 toward the outflow portion 31 in a stepwise manner for each rib 28.

As shown in FIG. 3, when the ribs 28 arranged in the X-axis direction are sequentially designated as a rib 28A, a rib 28B, a rib 28C, a rib 28D, and a rib 28E, starting from the inflow portion 30 toward the outflow portion 31, the relationship between the magnitudes of the lengths L of them in the X-axis direction is the rib 28A>the rib 28B>the rib 28C>the rib 28D>the rib 28E. The width H of each rib 28 in the Y-axis direction is preferably less than or equal to 2 mm, and more preferably less than or equal to 1.5 mm.

The inflow portion 30 is connected to one end of the mesh portion 29 in the X-axis direction, while the outflow portion 31 is connected to the other end of the mesh portion 29 in the X-axis direction, which is opposite to the one end. The inflow portion 30 and the outflow portion 31 each include multiple (six in the present embodiment) passages that extend linearly in the X-axis direction. These passages are arranged parallel to each other and at equal intervals in the Y-axis direction. The passages of the inflow portion 30 have a greater length in the X-axis direction than the passages of the outflow portion 31.

As shown in FIGS. 2 and 4, when the single cell 12 is viewed in the stacking direction Z, the mesh portion 29 and the ribs 28 of the gas passage 27 of the anode separator 24 are shifted in the X-axis direction from the mesh portion 29 and the ribs 28 of the gas passage 27 of the cathode separator 25. In FIG. 4, the gas passages 27 of the anode separator 24 are shown by the solid line, while the gas passages 27 of the cathode separator 25 are shown by the broken line.

As shown in FIGS. 2 and 3, the ends of the passages of the inflow portion 30 on the side opposite to the mesh portion 29 are connected to the through-hole hs1 by upstream coupling passages 34. The ends of the passages of the outflow portion 31 on the side opposite to the mesh portion 29 are connected to the through-hole hs2 by downstream coupling passages 35.

Fuel gas flows through the gas passages 27 of the anode separator 24 as reactant gas. Oxidant gas flows through the gas passages 27 of the cathode separator 25 as reactant gas. The reactant gases are supplied to the power generating unit 15 by flowing through the gas passages 27.

### Cooling Passage 21

As shown in FIG. 1, in the fuel cell stack 11, the anode separator 24 of one of two single cells 12 adjacent to each other in the stacking direction Z is in contact with the cathode separator 25 of the other single cell 12.

The cooling passages 21, through which cooling medium flows, are arranged between the anode separator 24 and the cathode separator 25, which are in contact with each other in the two adjacent single cells 12 in the stacking direction Z. A gasket (not shown) is arranged between the anode separator 24 and the cathode separator 25, which are in contact with each other, to provide a seal between the two single cells 12.

As shown in FIGS. 1 and 2, the separators 17 each include cooling grooves 36, which define the cooling passages 21. The cooling grooves 36 are located on the surface of the separator 17 that is opposite to the surface on which the gas passages 27 are formed. The cooling groove 36 is formed in conformance with the shape of the rear surface of the rib 28. The cooling passage 21 is formed by the gap between the cooling groove 36 of the anode separator 24 and the cooling groove 36 of the cathode separator 25. The cooling medium supplied from the cooling medium supply manifold M5 flows through the cooling passage 21 and is then discharged from the cooling medium discharge manifold M6.

### Operation of First Embodiment

When power is generated by the single cell 12, reactant gas is first supplied to the gas passage 27 through the through-hole hs1 of the separator 17 and is then discharged from the through-hole hs2. That is, in the gas passage 27, the reactant gas flows sequentially through the inflow portion 30, the mesh portion 29, and the outflow portion 31. The reactant gas is supplied to the power generating unit 15 by flowing through the mesh portion 29 of the gas passage 27. As a result, the power generating unit 15 generates power from the electrochemical reaction with the reactant gas.

The mesh portion 29 corresponding to the power generating unit 15 has multiple merging sections 33, where reactant gases merge. In the gas passage 27, the pressure loss of the reactant gas flowing downstream of the merging sections 33 is greater than the pressure loss of the reactant gas flowing upstream of the merging sections 33. Thus, in the parts of the gas passage 27 that are located downstream of the merging sections 33, the amount of the reactant gas flowing into the power generating unit 15 increases compared to the parts located upstream of the merging sections 33.

Additionally, the length L of each of the ribs 28 in the X-axis direction, which are arranged in the X-axis direction, decreases from the inflow portion 30 toward the outflow portion 31 in a stepwise manner for each rib 28. Multiple single cells 12 are stacked, each including two separators 17 arranged such that one end of the separator 17 in the X-axis direction is interchanged with the other end by inverting it around the hypothetical axis V. Thus, the positions of the gas passages 27 and the ribs 28 of the separators 17 that are in contact with each other in two adjacent single cells 12 in the stacking direction Z are shifted from each other in the X-axis direction.

Accordingly, recesses and projections respectively forming the gas passages 27 and the ribs 28 of the separators 17, which are in contact with each other in two adjacent single cells 12 in the stacking direction Z, are prevented from being fitted into each other. This stabilizes the surface pressure of the opposing surface 26 of the separator 17 on the power generating unit 15 in a well-balanced manner. Thus, the opposing surface 26 of the separator 17 is in closer contact with the power generating unit 15. This allows reactant gas to be efficiently supplied to the power generating unit 15 from the gas passages 27.

### Advantages of First Embodiment

The first embodiment described above in detail has the following advantages.

(1-1) In the single cell 12, the length L of each of the ribs 28 in the X-axis direction, which define the lattice pattern of the mesh portion 29 of the gas passage 27 and are arranged in the X-axis direction, decreases from the inflow portion 30 toward the outflow portion 31 in a stepwise manner for each rib 28.

This configuration produces the above-described operation of the first embodiment and thus allows reactant gas to be efficiently supplied to the power generating unit 15 from the gas passage 27.

(1-2) In the single cell 12, the two separators 17 have the identical structure.

In this configuration, the same component is used for the two separators 17. Thus, as compared to when the two separators 17 each have a different structure, the number of components is reduced.

(1-3) In the single cell 12, the width H of each rib 28 in the Y-axis direction is less than or equal to 2 mm.

This configuration allows a sufficient amount of reactant gas to be supplied to the portion of the power generating unit 15 that is in contact with the rib 28.

### Modifications

The first embodiment may be modified as follows. The first embodiment and the following modifications can be implemented in combination with each other as long as they remain within a technically consistent scope.

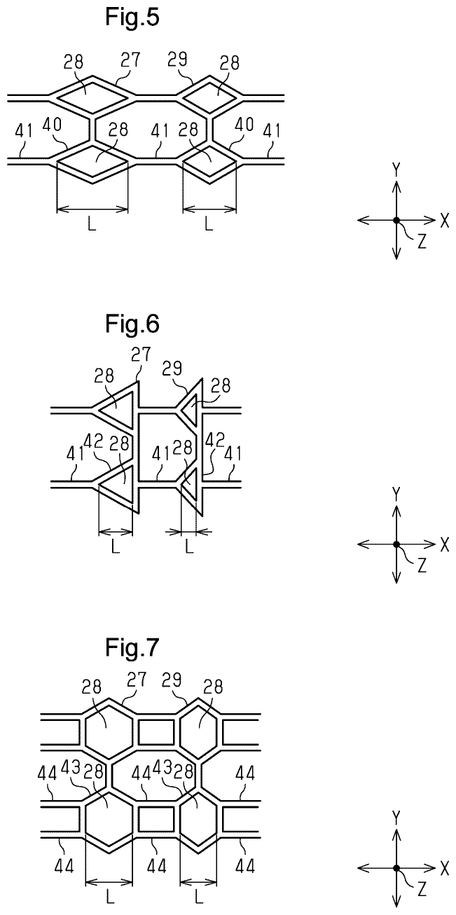

As shown in FIG. 5, each rib 28 may have a rhombus shape. Further, the mesh portion 29 of the gas passage 27 may be configured such that one rhombus continuous passage 40, surrounding the rib 28, and one straight linear passage 41, extending in the X-axis direction, are alternately arranged in the X-axis direction. In this case, the length L, in the X-axis direction, of each of the ribs 28 arranged in the X-axis direction may be increased or decreased in a stepwise manner from one side toward the other in the X-axis direction.

As shown in FIG. 6, each rib 28 may have a triangular shape. Further, the mesh portion 29 of the gas passage 27 may be configured such that one triangular continuous passage 42, surrounding the rib 28, and one straight linear passage 41, extending in the X-axis direction, are alternately arranged in the X-axis direction. In this case, the length L, in the X-axis direction, of each of the ribs 28 arranged in the X-axis direction may be increased or decreased in a stepwise manner from one side toward the other in the X-axis direction.

As shown in FIG. 7, each rib 28 may have a hexagonal shape rotated by 90°. Further, the mesh portion 29 of the gas passage 27 may be configured such that one hexagonal continuous passage 43, surrounding the rib 28, and two linear passages 44, arranged in the Y-axis direction and extending in the X-axis direction, are alternately arranged in the X-axis direction. In this case, the length L, in the X-axis direction, of each of the ribs 28 arranged in the X-axis direction may be increased or decreased in a stepwise manner from one side toward the other in the X-axis direction.

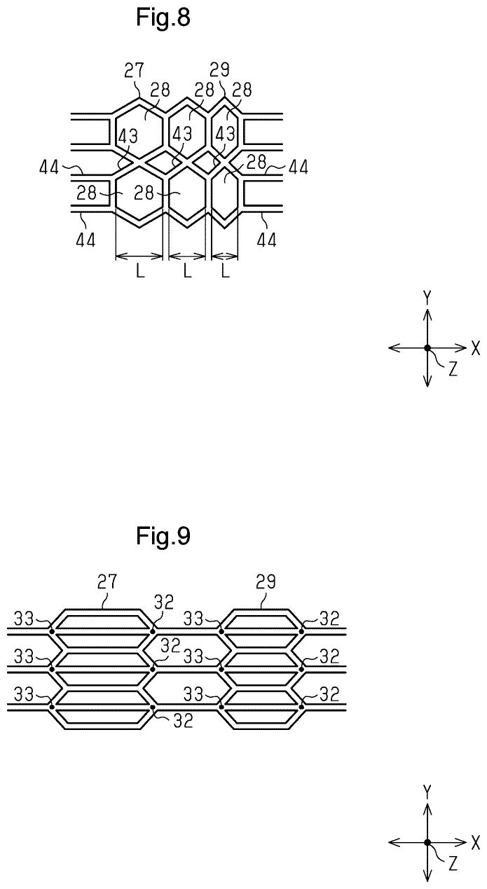

As shown in FIG. 8, each rib 28 may have a hexagonal shape rotated by 90°. Further, the mesh portion 29 of the gas passage 27 may be configured such that three hexagonal continuous passage 43, which surround the rib 28 and are continuous with each other in the X-axis direction, and two linear passages 44, which are arranged in the Y-axis direction and extend in the X-axis direction are alternately arranged in the X-axis direction. In this case, the length L, in the X-axis direction, of each of the three consecutive ribs 28 arranged in the X-axis direction may be increased or decreased in a stepwise manner from one side toward the other in the X-axis direction.

As shown in FIG. 9, the mesh portion 29 of the gas passage 27 may be configured such that the branching section 32 branches from one passage into three and the merging section 33 merges from three passages into one.

The mesh portion 29 of the gas passage 27 may be configured such that the branching section 32 branches from one passage into four or more and the merging section 33 merges from four or more passages into one.

The width H of the rib 28 in the Y-axis direction does not have to be less than or equal to 2 mm.

The two separators 17 may each have a different structure.

The width of the gas passage 27 on the downstream side of the branching section 32, where reactant gas splits, may be smaller than the width of the gas passage 27 on the upstream side of the branching section 32. Typically, in the gas passage 27, the pressure loss of the reactant gas flowing downstream of the branching section 32 is smaller than the pressure loss of the reactant gas flowing upstream of the branching section 32. This modification increases the pressure loss of the reactant gas flowing on the side of the gas passage 27 downstream of the branching section 32, thereby increasing the amount of the reactant gas flowing from the gas passage 27 to the power generating unit 15.

The width of the gas passage 27 on the downstream side of the branching section 32, where reactant gas splits, may be larger than the width of the gas passage 27 on the upstream side of the branching section 32.

In the single cell 12, the length L of each of the ribs 28 in the X-axis direction, which define the lattice pattern of the mesh portion 29 of the gas passage 27 and are arranged in the X-axis direction, may increase from the inflow portion 30 toward the outflow portion 31 in a stepwise manner for each rib 28.

In the single cell 12, the length L of each of the ribs 28 in the X-axis direction, which define the lattice pattern of the mesh portion 29 of the gas passage 27 and are arranged in the X-axis direction, may increase or decrease from the inflow portion 30 toward the outflow portion 31 in a stepwise manner for each set of two or more ribs 28.

The length L of the rib 28A may be equal to the length L of the rib 28B.

The length L of the rib 28B may be equal to the length L of the rib 28C.

The length L of the rib 28C may be equal to the length L of the rib 28D.

The length L of the rib 28D may be equal to the length L of the rib 28E.

The separator 17 does not have to be rectangular. Instead, the separator 17 may be polygonal (e.g., hexagonal or octagonal), circular, or elliptical.

The rib 28 does not have to be hexagonal. Instead, the rib 128 may be polygonal (e.g., quadrilateral or octagonal).

### Second Embodiment

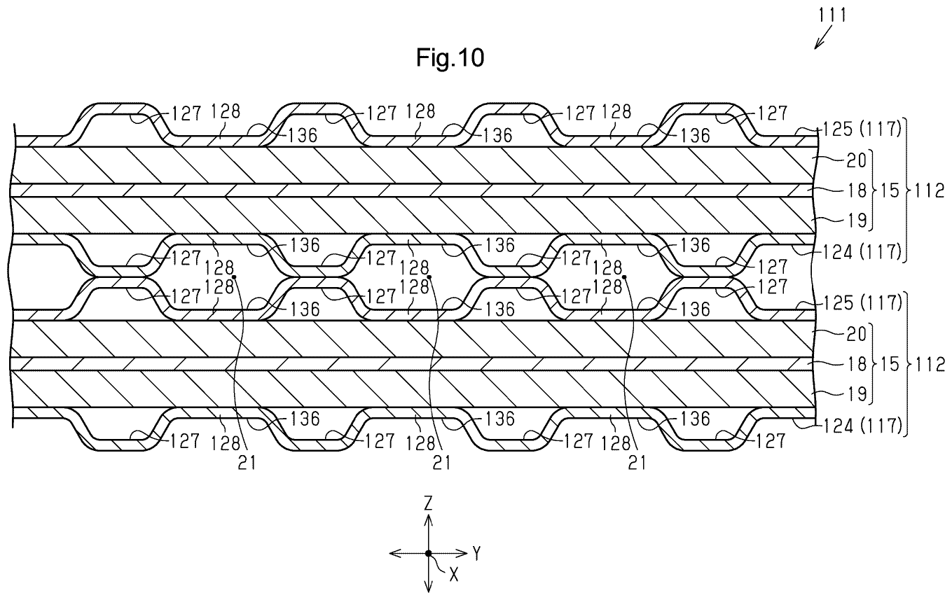

A single cell 112 for a fuel cell according to a second embodiment will now be described with reference to FIGS. 10 to 14, focusing on the differences from the first embodiment.

### Fuel Cell Stack 111

As shown in FIG. 10, a fuel cell stack 111 includes plate-shaped single cells 112 stacked on one another. In the following description, same reference numerals are given to those components that are the same as the corresponding components of the first embodiment. Such components will not be described in detail.

### Single Cell 112

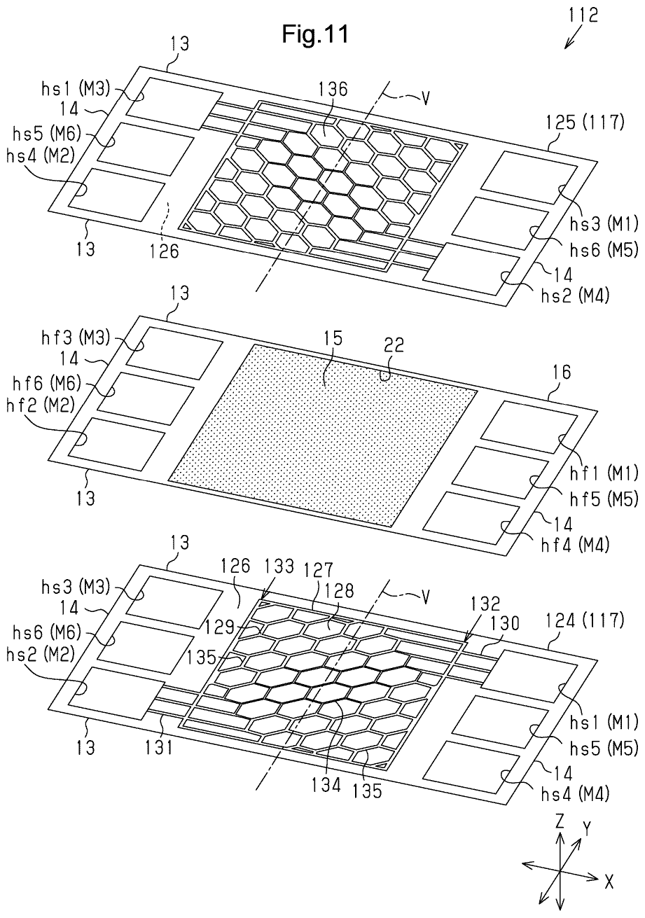

As shown in FIG. 11, each single cell 112 has the shape of, for example, a rectangular plate, and includes the power generating unit 15, the frame 16, and two separators 117.

### Separators 117

Referring to FIGS. 10 and 11, each separator 117 is formed by pressing a metal (e.g., stainless steel or titanium alloy) plate. One of the two separators 117 is disposed on the anode-side surface of the power generating unit 15, and the other is disposed on the cathode-side surface of the power generating unit 15.

Hereinafter, the separator 117 located on the anode-side surface of the power generating unit 15 may be referred to as the anode separator 124, and the separator 117 located on the cathode-side surface of the power generating unit 15 may be referred to as the cathode separator 125.

The anode separator 124 and the cathode separator 125 have an identical structure. The anode separator 124 and the cathode separator 125 are arranged in orientations that are inverted relative to each other about the hypothetical axis V, with respect to the power generating unit 15. The hypothetical axis V passes through the center of the separator 117 in the X-axis direction and extends in the Y-axis direction.

In the same manner as the first embodiment, the separator 117 has the through-holes hs1 to hs6, respectively form the manifolds M1 to M6.

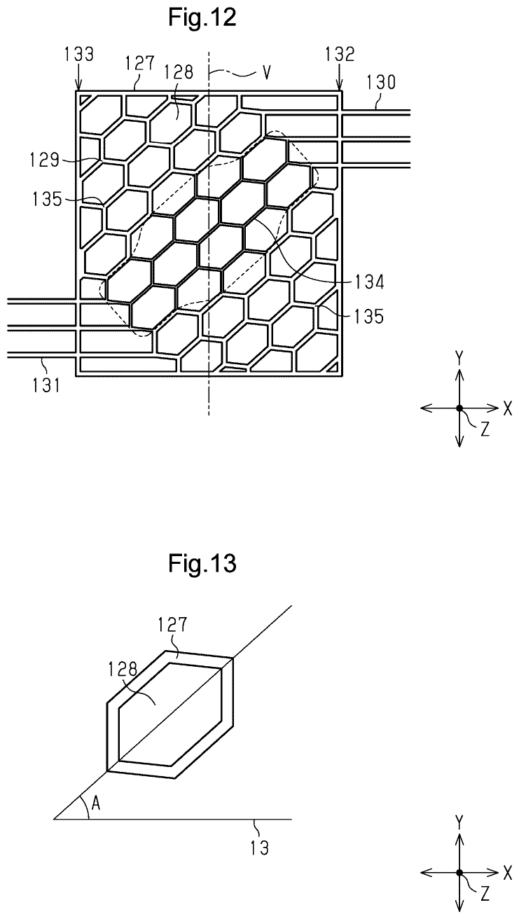

As shown in FIGS. 11 and 12, the separator 117 includes an opposing surface 126 opposed to the power generating unit 15. The opposing surface 126 has a groove-shaped gas passage 127 through which reactant gas flows, and a rib 128 adjacent to the gas passage 127. The gas passage 127 includes a mesh portion 129 formed in a lattice pattern, an inflow portion 130 through which reactant gas is drawn into the mesh portion 129, and an outflow portion 131 through which the reactant gas is discharged from the mesh portion 129.

The mesh portion 129 of the gas passage 127 is arranged in the entire region of the opposing surface 126 that is substantially rectangular in plan view, corresponding to the power generating unit 15. That is, the entire mesh portion 129 has a rectangular shape that corresponds to the power generating unit 15. The lattice pattern of the mesh portion 129 is formed by the rib 128. Thus, in the mesh portion 129, the gas passage 127 extends so as to surround the rib 128. The rib 128 has a hexagonal shape, which is an example of a polygonal shape.

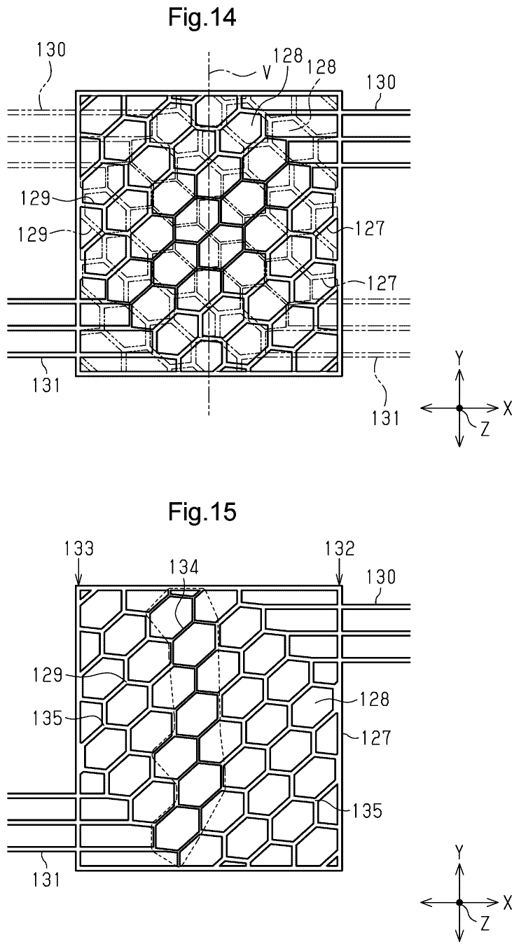

As shown in FIGS. 11, 13, and 14, the rib 128 extends in an inclined manner relative to the long side 13 of the separator 117. The angle A formed between the extending direction of the rib 128 and the extending direction of the long side 13 is set to be, for example, 45°. Thus, when the single cell 112 is viewed in the stacking direction Z, the mesh portion 129 and the rib 128 of the gas passage 127 of the anode separator 124 intersect the mesh portion 129 and the rib 128 of the gas passage 127 of the cathode separator 125, respectively. In FIG. 14, the gas passages 127 of the anode separator 124 are shown by the solid line, while the gas passages 127 of the cathode separator 125 are shown by the broken line.

As shown in FIGS. 11 and 12, a first end 132 of the mesh portion 129 in the X-axis direction has the inflow portion 130, through which reactant gas flows into the mesh portion 129. A second end 133 of the mesh portion 129 in the X-axis direction, which is opposite to the first end 132, has the outflow portion 131, through which reactant gas flows from the mesh portion 129. The inflow portion 130 and the outflow portion 131, for example, each include multiple (three in the present embodiment) grooves that extend linearly in the X-axis direction and are arranged at equal intervals in the Y-axis direction.

The inflow portion 130 is provided at the first end 132 of the mesh portion 129 in the X-axis direction, which is one end in the Y-axis direction. The outflow portion 131 is provided at the second end 133 of the mesh portion 129 in the X-axis direction, which is the other end in the Y-axis direction. Specifically, the inflow portion 130 and the outflow portion 131, which are provided in the mesh portion 129, are respectively located at the opposite ends in the Y-axis direction. The X-axis direction is an example of one direction. The inflow portion 130 connects the through-hole hs1 to the mesh portion 129. The outflow portion 131 connects the through-hole hs2 to the mesh portion 129.

A part of the mesh portion 129 is a restrictive passage 134. The restrictive passage 134 is configured to have a greater pressure loss when reactant gas flows compared to other parts of the mesh portion 129. The mesh portion 129 includes the restrictive passage 134 and a general passage 135, which is a part of the mesh portion 129 other than the restrictive passage 134. The restrictive passage 134 has a narrower width than the general passage 135. Thus, the restrictive passage 134 has a greater pressure loss when reactant gas flows compared to the general passage 135.

The width of the restrictive passage 134 is set to be, for example, approximately half the width of the general passage 135. The restrictive passage 134 is arranged in the mesh portion 129 to connect the inflow portion 130 to the outflow portion 131 by the shortest distance. That is, the restrictive passage 134 is located in a region along a straight line connecting the inflow portion 130 to the outflow portion 131 (the region enclosed by the broken line in FIG. 12).

Referring to FIGS. 11 and 12, fuel gas flows through the gas passages 127 of the anode separator 124 as reactant gas. Oxidant gas flows through the gas passages 127 of the cathode separator 125 as reactant gas. The reactant gases are supplied to the power generating unit 15 by flowing through the gas passages 127.

As shown in FIGS. 10 and 11, the separator 117, in the same manner as the first embodiment, includes cooling grooves 136 of the cooling passage 21.

### Operation of Second Embodiment

When power is generated by the single cell 112, reactant gas is first supplied to the gas passage 127 through the through-hole hs1 of the separator 117 and is then discharged from the through-hole hs2. That is, in the gas passage 127, the reactant gas flows sequentially through the inflow portion 130, the mesh portion 129, and the outflow portion 131. The reactant gas is supplied to the power generating unit 15 by flowing through the mesh portion 129 of the gas passage 127. As a result, the power generating unit 15 generates power from the electrochemical reaction with the reactant gas.

Normally, if the mesh portion 129 corresponding to the power generating unit 15 includes no restrictive passage 134, it causes reactant gas to mainly flow from the inflow portion 130 toward the outflow portion 131 along the shortest route. Thus, the flow of the reactant gas becomes uneven. Since the reactant gas has difficulty flowing to every part of the mesh portion 129, it is difficult to distribute the reactant gas uniformly across the entire mesh portion 129.

In the second embodiment, the restrictive passage 134 has a greater pressure loss when reactant gas flows compared to the general passage 135 of the mesh portion 129. The restrictive passage 134 is arranged in the mesh portion 129 to connect the inflow portion 130 to the outflow portion 131 by the shortest distance. This reduces the difference in the amount of reactant gas flowing between the general passage 135 and the restrictive passage 134 in the mesh portion 129.

Since such a configuration allows the reactant gas to flow to every part of the mesh portion 129, the uneven distribution of the reactant gas flow in the mesh portion 129 is eliminated. As a result, the reactant gas flows uniformly across the entire mesh portion 129 and is thus uniformly supplied to the entire power generating unit 15. This improves the power generation efficiency in the power generating unit 15.

### Advantages of Second Embodiment

The second embodiment described above in detail has the following advantages.

(2-1) In the single cell 112, the restrictive passage 134 is arranged in the mesh portion 129 to connect the inflow portion 130 to the outflow portion 131 by the shortest distance.

This configuration produces the above-described operation of the second embodiment. Accordingly, the uneven distribution of the reactant gas flow in the mesh portion 129 of the gas passage 127 is eliminated, allowing the reactant gas to be uniformly supplied to the entire mesh portion 129. As a result, the reactant gas is uniformly supplied to the entire power generating unit 15.

(2-2) In the single cell 112, the two separators 117 have the identical structure.

In this configuration, the same component is used for the two separators 117. Thus, as compared to when the two separators 117 each have a different configuration, the number of components is reduced.

(2-3) In the single cell 112, the separator 117 has a rectangular shape. The lattice pattern of the mesh portion 129 is formed by the hexagonal rib 128. The rib 128 extends in an inclined manner relative to the long side 13 of the separator 117.

In this configuration, as viewed in the stacking direction Z, in which the two separators 117 sandwich the power generating unit 15, the mesh portions 129 of the gas passages 127 of the two separators 117 intersect each other. Accordingly, when multiple single cells 112 are stacked, recesses and projections respectively forming the gas passages 127 and the ribs 128 of the separators 117, which are in contact with each other in two adjacent single cells 112 in the stacking direction Z, are prevented from being fitted into each other. This ensures the contact of the opposing surface 126 of the separator 117 on the power generating unit 15.

### Modifications

The above-described second embodiment may be modified as follows. The second embodiment and the following modifications can be combined as long as the combined modifications remain technically consistent with each other.

As shown in FIG. 15, the restrictive passage 134 may be arranged in the mesh portion 129 to separate the inflow portion 130 from the outflow portion 131. In this case, the restrictive passage 134 extends across the entire mesh portion 129 in the Y-axis direction. That is, the restrictive passage 134 is located in a region along a straight line that extends in the Y-axis direction to separate the inflow portion 130 from the outflow portion 131 (the region enclosed by the broken line in FIG. 15).

If the mesh portion 129 includes no restrictive passage 134, it causes reactant gas to mainly flow from the inflow portion 130 toward the outflow portion 131 along the shortest route, resulting in the uneven distribution of the reactant gas flow. Since the reactant gas has difficulty flowing to every part of the mesh portion 129, it is difficult to distribute the reactant gas uniformly across the entire mesh portion 129.

In the above-described modification, the restrictive passage 134 has a greater pressure loss when reactant gas flows compared to the general passage 135 of the mesh portion 129. The restrictive passage 134 is arranged in the mesh portion 129 to separate the inflow portion 130 from the outflow portion 131. Thus, the reactant gas that has flowed from the inflow portion 130 to the mesh portion 129 flows through the entire part of the mesh portion 129 located closer to the inflow portion 130 than the restrictive passage 134, and then flows through the restrictive passage 134. After that, the reactant gas flows through the entire part of the mesh portion 129 located closer to the outflow portion 131 than the restrictive passage 134. Finally, the reactant gas flows from the mesh portion 129 to the outflow portion 131. This eliminates the uneven distribution of the reactant gas flow in the mesh portion 129 of the gas passage 127, and thus allows the reactant gas to be uniformly supplied to the entire mesh portion 129. As a result, the reactant gas is uniformly supplied to the entire power generating unit 15.

As shown in FIG. 16, the restrictive passage 134 may be arranged in the mesh portion 129 to separate the inflow portion 130 from the outflow portion 131. In this case, the restrictive passage 134 extends across the entire mesh portion 129 in the X-axis direction. That is, the restrictive passage 134 is located in the region along a straight line that extends in the X-axis direction to separate the inflow portion 130 from the outflow portion 131 (the region enclosed by the broken line in FIG. 16). Even such a configuration achieves the same operation and advantages as those in FIG. 15.

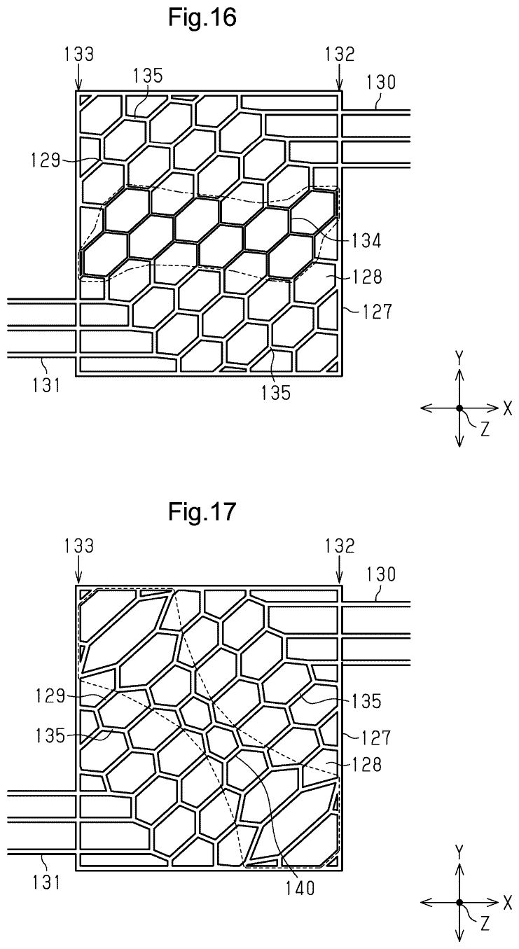

As shown in FIG. 17, a restrictive passage 140 may be arranged in the mesh portion 129 to separate the inflow portion 130 from the outflow portion 131. In this case, the restrictive passage 140 is located in a linear region extending along one of the diagonals of the mesh portion 129 (the region enclosed by the broken line in FIG. 17). In this case, while the restrictive passage 140 has the same width as the general passage 135, the restrictive passage 140 is configured to form shorter or longer hexagons compared to those formed by the general passage 135. The relatively short hexagonal passages of the restrictive passage 140 are more significantly bent than the hexagonal passages of the general passage 135. As a result, the pressure loss of reactant gas flowing through the restrictive passage 140 is greater than that of the general passage 135. The relatively long hexagonal passages of the restrictive passage 140 are longer than the hexagonal passages of the general passage 135. As a result, the pressure loss of reactant gas flowing through the restrictive passage 140 is greater than that of the general passage 135. The restrictive passage 140, which is arranged in the region extending linearly, is configured such that, for example, the hexagon at the middle is shortest and the length of the hexagon increases toward the opposite ends. In this case, the pressure loss of the reactant gas flowing through the restrictive passage 140, which is arranged in the linear region, is highest at the middle and decreases toward the opposite ends. Even such a configuration achieves the same operation and advantages as those in FIG. 15.

The separator 117 does not have to be rectangular. Instead, the separator 117 may be polygonal (e.g., hexagonal or octagonal), circular, or elliptical.

The rib 128 does not have to be hexagonal. Instead, the rib 128 may be polygonal (e.g., quadrilateral or octagonal), circular, or elliptical.

The two separators 117 of the single cell 112 may each have a different structure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A single cell for a fuel cell, the single cell comprising:
a power generating unit that includes a membrane electrode assembly; and
two separators that sandwich the power generating unit, wherein
each of the separators includes an opposing surface opposed to the power generating unit, the opposing surface having a gas passage configured such that reactant gas flows through the gas passage and ribs adjacent to the gas passage,
the gas passage includes:
a mesh portion formed in a lattice pattern on a region of the opposing surface corresponding to the power generating unit;
an inflow portion connected to one end of the mesh portion in one direction, the inflow portion being configured such that the reactant gas flows through the inflow portion into the mesh portion; and
an outflow portion connected to the other end of the mesh portion opposite to the one end in the one direction, the outflow portion being configured such that the reactant gas flows through the outflow portion from the mesh portion,
the lattice pattern of the mesh portion is formed by the ribs,
the ribs forming the lattice pattern include ribs arranged in the one direction, and
a length of each of the ribs arranged in the one direction increases or decreases from the inflow portion toward the outflow portion in a stepwise manner for at least one of the ribs.

2. The single cell for the fuel cell according to claim 1, wherein
the two separators have an identical structure.

3. The single cell for the fuel cell according to claim 1, wherein
a width of the rib in a direction that is orthogonal to the one direction is less than or equal to 2 mm.

4. A single cell for a fuel cell, the single cell comprising:
a power generating unit that includes a membrane electrode assembly; and
two separators that sandwich the power generating unit, wherein
each of the separators includes an opposing surface opposed to the power generating unit, the opposing surface having a gas passage configured such that reactant gas flows through the gas passage,
the gas passage includes:
a mesh portion formed in a lattice pattern on a region of the opposing surface corresponding to the power generating unit;
an inflow portion provided at a first end of the mesh portion in one direction, the inflow portion being configured such that the reactant gas flows through the inflow portion into the mesh portion;
an outflow portion provided at a second end of the mesh portion opposite to the first end in the one direction, the outflow portion being configured such that the reactant gas flows through the outflow portion from the mesh portion; and
a restrictive passage that is a part of the mesh portion and is configured to have a greater pressure loss when the reactant gas flows compared to other parts of the mesh portion, and
the restrictive passage is arranged in the mesh portion to connect the inflow portion to the outflow portion by a shortest distance.

5. The single cell for the fuel cell according to claim 4, wherein
the two separators have an identical structure.

6. The single cell for the fuel cell according to claim 5, wherein
each of the separators has a rectangular shape,
the lattice pattern of the mesh portion is formed by a polygonal rib, and
the rib extends in an inclined manner relative to a side of the separator.

7. A single cell for a fuel cell, the single cell comprising:
a power generating unit that includes a membrane electrode assembly; and
two separators that sandwich the power generating unit, wherein
each of the separators includes an opposing surface opposed to the power generating unit, the opposing surface having a gas passage configured such that reactant gas flows through the gas passage,
the gas passage includes:
a mesh portion formed in a lattice pattern on a region of the opposing surface corresponding to the power generating unit;
an inflow portion provided at a first end of the mesh portion in one direction, the inflow portion being configured such that the reactant gas flows through the inflow portion into the mesh portion;
an outflow portion provided at a second end of the mesh portion opposite to the first end in the one direction, the outflow portion being configured such that the reactant gas flows through the outflow portion from the mesh portion; and
a restrictive passage that is a part of the mesh portion and is configured to have a greater pressure loss when the reactant gas flows compared to other parts of the mesh portion, and
the restrictive passage is arranged in the mesh portion to separate the inflow portion from the outflow portion.

8. The single cell for the fuel cell according to claim 7, wherein
the two separators have an identical structure.

9. The single cell for the fuel cell according to claim 8, wherein
each of the separators has a rectangular shape,
the lattice pattern of the mesh portion is formed by a polygonal rib, and
the rib extends in an inclined manner relative to a side of the separator.
